(19) United States
(12) Patent Application Publication
(10) Pub. No.: US 2005/0243484 A1
(43) Pub. Date: Nov. 3, 2005

(54) Electric leak breaker for self-test

(76) Inventor: Byung-Kook Kim, Busan-City (KR)

Correspondence Address: HARNESS, DICKEY & PIERCE, P.L.C., P.O. BOX 8910, RESTON, VA, 20195, US

(21) Appl. No.: 10/895,104

(22) Filed: Jul. 21, 2004

(30) Foreign Application Priority Data
Apr. 30, 2004 (KR) 2004-30319

(51) Int. Cl. H02H 3/00

(52) U.S. Cl. 361/42

(57) ABSTRACT

The present invention disclosed herein is an electric leak breaker for self-test. The electric leak breaker for self-test comprises power supply lines for connecting a power source supply with a load; a zero-phase current transformer installed on the power supply lines and for sensing a current difference between the power supply lines; a leakage current detecting unit connected to the zero-phase current transformer for detecting whether a leakage current occurs to generate a detection signal; a driving unit for making the power supply lines broken when a critical voltage or a voltage higher than the critical voltage is provided; and a self-test unit for periodically inducing the leakage current at the power supply lines to test whether the leakage detecting unit is normally operating, and for providing a lower voltage than the critical voltage to the driving unit to test whether the driving unit is normally operating in a self-test operation. According to the present invention, it is possible to periodically test the electric leak breaker as well as to overcome an inconvenience to push a reset button.

This application claims priority from Korean Patent Application No. 2004-30319, filed on Apr. 30, 2003, the contents of which is herein incorporated by reference in its entirety.

### FIELD OF THE INVENTION

This disclosure generally relates to electric leak breakers and, more specifically, to an electric leak breaker capable of self-testing periodically.

### BACKGROUND OF THE INVENTION

In general, electric leak breakers perform functions to sense a leakage current and breaks electric current from loads when leakage current is generated at loads. There is an advantage to prevent the fire as well as shock caused by a leakage of electricity.

FIG. 1 is a schematic diagram showing an electric leak breaker according to a conventional art. The electric leak breaker shown in FIG. 1 is disclosed in Korean Utility Model Patent Publication (Application No. 20-2003-30832). Referring to FIG. 1, the electric leak breaker according to the conventional art comprises power supply lines H and N for connecting a power source supply 1 with a load 2, a zero-phase current transformer (ZTC) 10 for sensing an electric difference of the power supply lines, a leakage current detecting unit 20 for amplifying a sense signal generated from the zero-phase current transformer 10 in a leakage of electricity to generate a detection signal, a driving unit 30 for breaking the power supply lines depending on the detection signal generated from the leakage current detecting unit 20, a breaking unit 40 installed on the power supply line and for turning on/off the power supply lines by a control of the driving unit 30, and a test circuit 50 connected to the power supply lines and for generating a leakage current in a test operation.

The test circuit 50 includes a first switch SW1 and a resistance R. When a test button (TEST) 51 is pushed in the test operation, a leakage current flows in the power supply lines. The breaker unit 40 comprises a second switch SW2 installed on a hot line H and a third switch SW3 installed on a neutral line N. In addition, if there is a leakage current in the power supply lines, the breaker unit 40 becomes turned off by a control of the driving unit 30. The breaker unit 40 is connected again in pushing a reset button 41.

A conventional electric leak breaker is operated when leakage current is generated at a load as followings. Currents through a power lines H flows to a neutral line N via a load 2. When leakage current is generated at the load 2, current capacity is decreased so that current capacity along the power line H and the neutral line N becomes different. The zero-phase current transformer 10 senses the changed current capacity. The leakage detection unit 20 senses a voltage difference between both ends of the zero-phase current transformer 10 to detect whether leakage current is generated or not and then generate a detection signal according to a detection result. The driving unit 30 turns off the second switch SW2 and a third switch of the breaking unit 40 in response to the detection signal, and thereby preventing accidents caused by leakage current.

In the meanwhile, the conventional electric leak breaker is operated in a test operation as follows.

In advance, the first switch SW1 of the test circuit 50 is closed in pushing the test button. When the first switch SW1 is turned on, the current of the power line H partially flows to the neutral line N without passing by the load 2. As a result, current capacity flowing to the power line H and the neutral line N becomes different. The following operations are progressed in the same way operations when leakage current is generated at the load. The second and third switches of the breaking unit 40 become turned off. The turned-off second and third switches become turned on again in pushing the reset button 41.

In order to safety supervision about electric leak breakers, it is necessary for a user to periodically test electric leak breakers during a regular period. In other words, there is a request for a user to periodically test whether electric leak breakers are normally operated by pushing the test button 51. Furthermore, there is an inconvenience to push the reset button 41 when the test operation is completed.

### SUMMARY OF THE INVENTION

Accordingly, the present invention is directed to an electric leak breaker capable of periodically performing self-test operation as well as preventing an inconvenience of pushing a reset button after completing a test operation.

In one aspect of the present invention, there is provided an electric leak breaker for self-test which comprises power supply lines for connecting a power source supply with a load; a zero-phase current transformer installed on the power supply lines and for sensing a current difference between the power supply lines; a leakage current detecting unit connected to the zero-phase current transformer for detecting whether a leakage current occurs to generate a detection signal; a driving unit for making the power supply lines broken when a critical voltage or a voltage higher than the critical voltage is provided; and a self-test unit for periodically inducing the leakage current at the power supply lines to test whether the leakage detecting unit is normally operating, and for providing a lower voltage than the critical voltage to the driving unit to test whether the driving unit is normally operating in a self-test operation. In this case, the self-test unit provides the critical voltage or a voltage higher than the critical voltage to the driving unit when the leakage current occurs at the load.

In this embodiment, the driving unit provides a power to the self-test unit and breaks a power provided to the self-test unit when a predetermined voltage is applied to the self-test unit. In this case, the driving unit includes a rectifier circuit connected to the power supply lines to convert an alternating wave to a rectification wave and for providing the rectification wave to the self-test unit.

In this embodiment, the self-test unit periodically induces the leakage current to the power supply lines referring to a frequency of the rectification wave supplied from the rectifier circuit. The self-test unit which comprises a leakage generating circuit for inducing the leakage current at the power supply lines in response to a self-test signal; a control unit for providing the self-test signal referring to the frequency of the rectification wave, for detecting whether a detection signal generates in the leakage current detecting unit, and providing a lower voltage lower than a critical voltage to the driving unit; and a display device for indicating a malfunction of the leakage current detecting unit if the detection signal is not generated. The display device indicates the malfunction of the driving unit to the outside if a power supplied from the driving unit is not broken. In this case, the display device is a LED.

In this embodiment, the leakage current generating circuit includes a resistance R and a thyristor SCR, and a gate terminal of the thyristor receives the self-test signal.

In this embodiment, the electric leak current breaker further includes a passive test circuit for passively generating a leakage current at the power supply lines. In this case, the control unit provides a critical voltage or a voltage higher than the critical voltage to the driving unit in a passive test operation.

### BRIEF DESCRIPTION OF THE DRAWINGS

FIG. 1 is a schematic block diagram showing an electric leak breaker according to a conventional art.

FIG. 2 is a schematic block diagram showing an electric leak breaker according to the present invention.

FIG. 3 is a schematic block diagram showing an embodiment of the electric leak breaker according to the present invention.

### DETAILED DESCRIPTION OF THE PREFERRED EMBODIMENT

The present invention will be described more fully hereinafter with reference to the accompanying drawings, in which exemplary embodiments of the invention are shown.

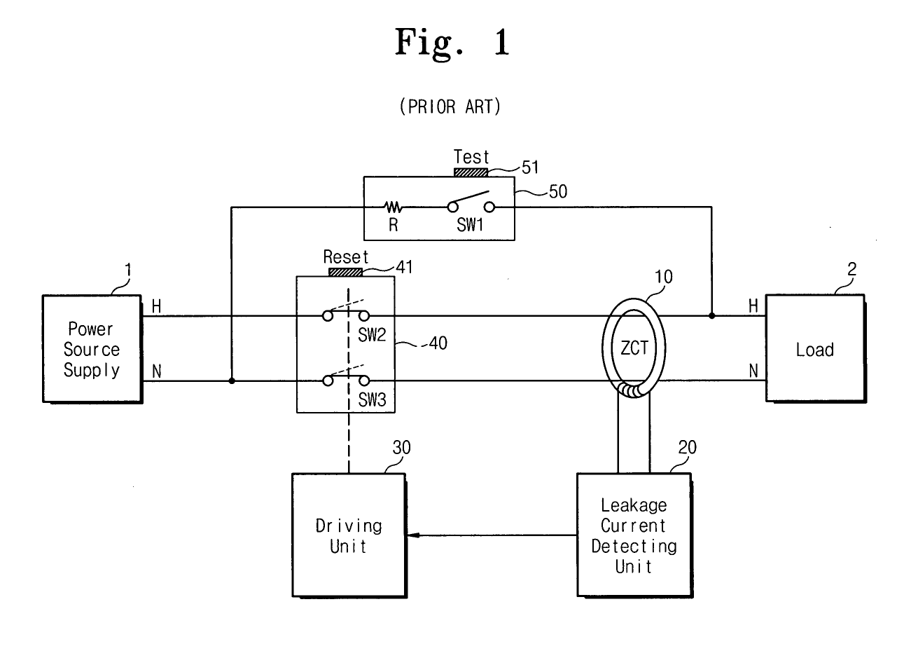

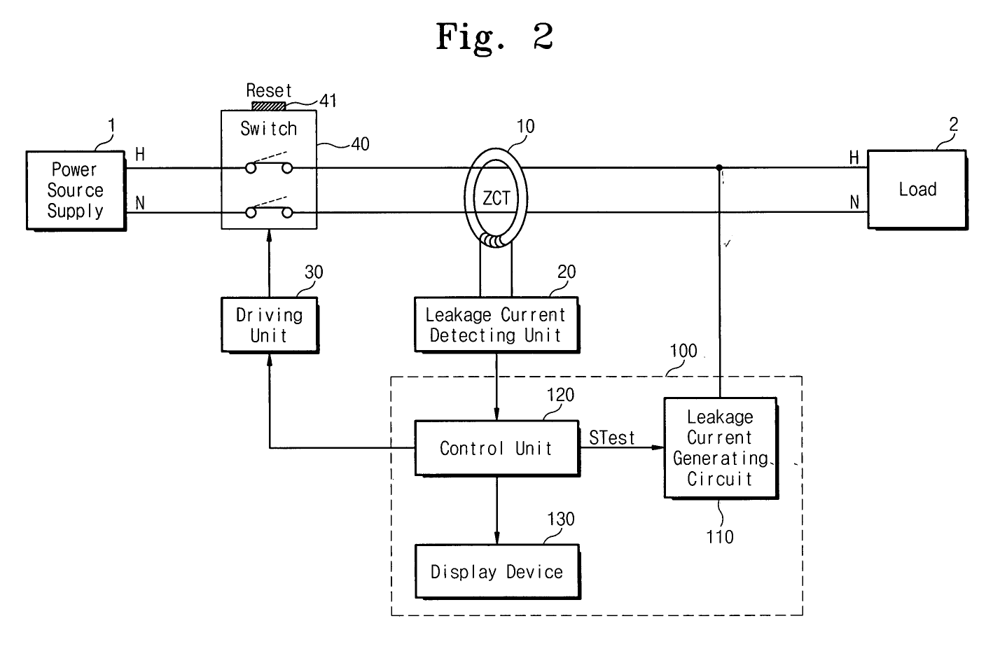

FIG. 2 is a schematic block diagram showing an electric leak breaker according to the present invention. In this case, the same references shown in FIG. 1 indicate the same members performing the same functions. An electric leak breaker for self-test according to the present invention is automatically capable of testing whether the electric leak breaker is normally operated by periodically generating leakage current to a power supply line. In addition, since the electric leak breaker may be tested without breaking the power supply line, it is possible to overcome an inconvenience of pushing a reset button.

Referring to FIG. 2, the electric leak breaker for self-test comprises power supply lines H and N for connecting a power source supply 1 with a load 2, a zero-phase current transformer (ZCT) 10 for sensing a current difference between the power supply lines, and a leakage current detection unit 20 for sensing a voltage difference at both ends of the zero-phase current transformer 10 to detect whether leakage current is generated and then generating a detection signal. A breaking unit 40 is installed on the power supply lines. The breaking unit 40 comprises switches having switching contacts. The switch is installed on a power line H and a neutral line N, respectively. The breaker 40 has a reset button 41. When the power supply lines are cut-off, the switch is closed by pushing the reset button 41. As a result, the power supply line is connected again.

The breaking unit 40 is controlled by a driving unit 30. When leakage current more than a reference leakage current is generated at a load, a predetermined force is applied to the braking unit 40 by the driving unit 30, and thereby breaking the power supply line. To the contrary, the power supply line is not broken by applying a force smaller than the predetermined force to the breaking unit 40 in a self-test operation.

A self-test unit 100 is connected between the leakage current unit 20 and the driving unit 30.

The self-test unit 100 receives a detection signal from the leakage current detection unit 20 to provide a driving signal to the driving unit 30. The self-test unit 100 includes a leakage generating circuit 110, a control unit 120 and a display device 130.

The leakage current generating circuit 110 generates leakage current to the power supply line in response to a self-test signal STest. The control unit 120 generated the self-testing signal STest periodically. The self-test signal STest may be generated by a timer (not shown) embedded in the control unit 120. Additionally, the self-test signal STest may be generated by sensing a signal (e.g., a rectification wave or an alternating current wave, which has a regular frequency).

In another approach, the control unit 120 tests whether the leakage current detection unit 20 is normally operated referring to a detection signal generated from the leakage current detection unit 20 in a self-test operation. The control unit 120 generates the self-test signal STest to induce a leakage current at the power supply lines. At this time, if a detection signal under a reference signal is generated at the leakage current detection unit 20, the control unit generates a signal for indicating a malfunction of the leakage current detection unit 20.

Moreover, the control unit 120 applies the driving signal to the driving unit 30 in order to test whether the driving unit 30 is normally operating when the leakage current detection unit 20 is normally operated. The driving signal has various values according to whether leakage current is generated at the load or whether leakage current is generated by the self-test operation.

When leakage current more than a reference leakage current is generated at the load, the control unit 120 applies a driving signal with a high voltage to the driving unit 30, and thereby breaking the power supply line. However, in the self-test operation, the control unit 120 applies a driving signal with a low voltage in comparison with a voltage when leakage current is generated at the load to the driving unit 30, and thereby not breaking the power supply line. Under this condition, the control unit 120 tests only whether the driving unit 30 is normally operating or not.

That is, the driving unit 30 may break or may not break the power supply line according to a voltage level of the driving signal. In this case, a voltage level of minimal driving signal for breaking the power supply line is defined as a critical voltage. The critical voltage is understood as the same meaning within the present specification including claims. If the critical voltage or a voltage higher than the critical voltage is applied, the driving unit 30 breaks the power supply line. Unlike this, if a voltage lower than the critical voltage is applied, the driving unit does not break the power supply line.

The display device 130 indicates whether the leakage current detection unit 20 or the driving unit 30 is normally operating according to a test result of the control unit 120 to the outside.

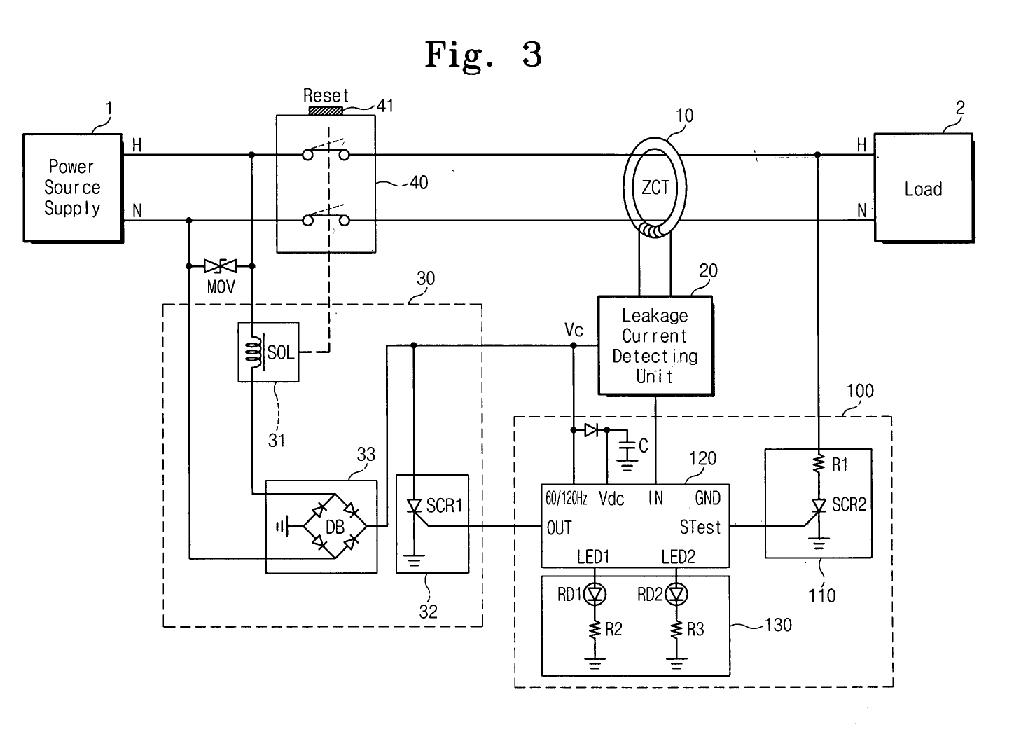

FIG. 3 is a schematic block diagram showing an embodiment of an electric leak breaker according to the present invention. Referring to FIG. 3, an electric leak breaker for self-test according to the present invention which comprises power supply lines H and N for connecting the power source supply 1 with the load 2, a zero-phase current transformer (ZCT) 10 for sensing a current difference between the power supply lines, a leakage current detection unit 20 for generating a detection signal, a breaker 40 installed on the power supply line, a driving unit 30 for controlling the breaker 40 and a self-test unit 100.

The driving unit 30 includes a trip-coil (SOL) 31, a thyristor (SCR1) 32, and a diode bridge (DB) 33. The trip-coil 31 comprises a solenoid using electromagnetic induction phenomenon and applies a predetermined force to the breaker, and thereby breaking the power supply line when leakage current more than a reference leakage current is generated at the load.

The thyristor 32 becomes turned on/off in response to a driving signal applied to a gate terminal. If the thyristor 32 is turned on, electromagnetic induction occurs to the trip-coli 31.

The diode bridge 33 is connected between the trip-coil 31 and the thyristor 32. In addition, the diode bridge 33 is connected between the power supply lines and transforms an alternating current wave to a rectification wave. If the alternating current wave is 60 Hz, the rectification wave is a ripple wave having 120 Hz. The rectification wave generated from the diode bridge 33 is used as a power source of the leakage current detection unit 20 or the self-test unit 100. If the thyristor 32 is turned on by applying a predetermined voltage to the gate terminal of the thyristor 32, the rectification wave is not provided to the self-test unit 100 any more.

The self-test unit 100 includes a leakage generating circuit 110 for generating leakage current to the power supply lines in response to a self-test signal STest, a control unit 120 for periodically providing the self-test signal STest to the leakage current generating circuit 110 and a display device 130 for indicating a test result to the outside.

The leakage current generating circuit 110 includes a resistance R and a thyristor SCR2. The self-test signal STest is periodically applied to the gate terminal of the thyristor SCR2. If the self-test signal STest is applied, current of the power supply line H flows via the leakage current generating circuit 110 to a ground. At this time, a current difference is generated between the power line H and the neutral line N.

The control unit 120 provides the self-test signal STest to the leakage current generating circuit 110 periodically. The control unit 120 receives a rectification wave Vc (e.g., a ripple wave having 60 Hz or 120 Hz) generated from the diode bridge 33 to generated the self-test signal STest periodically. In addition, the rectification wave Vc penetrates an diode and a capacitor C to be smoothed, and is used as a direct power voltage Vdc in the control unit 120.

The control 120 unit receives a detection signal generated from the leakage current detection unit 20 in a self-test operation through an input terminal IN and then test whether the leakage current unit 20 is normally operating or not. Additionally, the control unit 120 generates a signal for indicating a malfunction of the leakage current unit 20 in case that the detection signal is not generated or a detection signal under a reference value is generated in the leakage current 20 in a self-test operation. The display device 130 receives a signal from the control unit 120 to indicate whether the leakage current unit 20 is abnormally operating or not.

In the meanwhile, the control unit 120 tests whether the leakage current unit 20 is normally operating in the self-test operation and then tests whether the driving unit 30 is normally operating. The control unit 120 applies a driving signal to the gate terminal of the thyristor 32 located in the driving unit 30 by an output terminal OUT.

The driving signals have different voltage levels in accordance with leakage current generated at the load or by the self-test operation. When leakage current is generated at the load, the control unit 120 by-passes a signal received by the input terminal IN to the output terminal OUT or outputs a triggered signal around a peak of the rectification wave Vc as a driving signal. The reason for this is to generate a driving signal having a critical voltage or a voltage higher than the critical voltage. If the critical voltage or the voltage higher than the critical voltage is applied to the gate terminal of the thyristor 32, the thyristor 32 becomes turned on, and the trip-coil 31 breaks the power supply line.

However, in the self-test operation, the signal received through the input terminal IN is delayed to output the trigger signal at a portion where the rectification wave Vc is decreased to a driving signal so as to output a driving voltage lower than the critical voltage. At this time, if the driving signal with lower voltage than the critical voltage is applied to the gate terminal of the thyristor 32, the thyristor 32 becomes turned on, and however, the power supply line does not broken.

If the thyristor 32 is turned on, the rectification wave Vc is not provided to the self-test unit 100 any more. At this time, the control unit 120 detects whether the driving unit 20 is normally operated considering that power is cut-off. In other words, if the rectification wave Vc being provided to the control unit 120 in the self-test operation is unexpectedly broken, the control unit 120 detects that the driving unit 30 is normally operating. But, if the power supply is not broken although the driving signal is applied to the driving unit 30 in the self-test operation, the control unit 120 generates a signal for indicating a malfunction of the driving unit 30. At this time, the display device indicates the malfunction of the driving unit 30 to the outside.

In FIG. 3, the display device 130 includes one resistance (R2 or R3) and one LED (RD1 or RD2). For instance, if there is a malfunction in the leakage current detection unit 20 or the driving unit 30, the display device 130 respectively indicates the malfunctions to the outside through LED (RD1) or LED (RD2). While the display device is described in connection with the LED, it will be understood b that various changes may be embodied through alarm devices.

In another approach, as not shown in FIG. 3, the electric leak breaker according to the present invention may further include the test circuit 50 shown in FIG. 1. The test circuit 50 (see FIG. 1) passively generates leakage current to the power supply line. At this time, the control unit provides the critical voltage or a voltage higher than the critical voltage to the driving unit in a passive-testing operation, and thereby breaking the power supply lines. By pushing the reset button 51, the broken power supply line is connected again.

As previously mentioned, the electric leak breaker according to the present invention has many advantages. In advance, since the electric leak breaker is capable of periodically self-test without breaking the power supply lines, it is possible to overcome inconvenience of continuously testing the electric leak breaker during a regular period. Furthermore, it is possible to overcome inconvenience of recovering the power supply line by pushing the reset button after a test operation.

Changes can be made to the invention in light of the above detailed description. In general, in the following claims, the terms used should not be construed to limit the invention to the specific embodiments disclosed in the specification and the claims, but should be construed to include all methods and devices that are in accordance with the claims. Accordingly, the invention is not limited by the disclosure, but instead its scope is to be determined by the following claims.

1. An electric leak breaker for self-test comprising:
power supply lines for connecting a power source supply with a load;
a zero-phase current transformer installed on the power supply lines and for sensing a current difference between the power supply lines;
a leakage current detecting unit connected to the zero-phase current transformer for detecting whether a leakage current occurs to generate a detection signal;
a driving unit for making the power supply lines broken when a critical voltage or a voltage higher than the critical voltage is provided; and
a self-test unit for periodically inducing the leakage current at the power supply lines to test whether the leakage detecting unit is normally operating, and for providing a lower voltage than the critical voltage to the driving unit to test whether the driving unit is normally operating in a self-test operation.

2. The electric leak breaker for self-test of claim 1, wherein the self-test unit provides the critical voltage or a voltage higher than the critical voltage to the driving unit when the leakage current occurs at the load.

3. The electric leak breaker for self-test of claim 1, wherein the driving unit provides a power to the self-test unit, and
wherein the driving unit breaks a power provided to the self-test unit when a predetermined voltage is applied to the self-test unit.

4. The electric leak breaker for self-test of claim 3, wherein the driving unit includes a rectifier circuit connected to the power supply lines to convert an alternating wave to a rectification wave and for providing the rectification wave to the self-test unit.

5. The electric leak breaker for self-test of claim 4, wherein the self-test unit periodically induces the leakage current at the power supply line referring to a frequency of the rectification wave supplied from the rectifier circuit.

6. The electric leak breaker for self-test of claim 5, wherein the self-test unit comprises:
a leakage generating circuit for inducing the leakage current at the power supply lines in response to a self-test signal;
a control unit for providing the self-test signal referring to the frequency of the rectification wave, for detecting whether a detection signal generates in the leakage current detecting unit, and providing a lower voltage lower than a critical voltage to the driving unit; and
a display device for indicating a malfunction of the leakage current detecting unit if the detection signal is not generated.

7. The electric leak breaker for self-test of claim 6, wherein the display device indicates the malfunction of the driving unit to the outside when a power supplied from the driving unit is not broken.

8. The electric leak breaker for self-test of claim 6, wherein the leakage current generating circuit includes a resistance R and a thyristor SCR, and
wherein a gate terminal of the thyristor receives the self-test signal.

9. The electric leak breaker for self-test of claim 6, wherein the display device is a LED.

10. The electric leak breaker for self-test of claim 6, wherein the display device is an alarm unit.

11. The electric leak breaker for self-test of claim 1, further comprising a passive test circuit for passively generating a leakage current at the power supply lines.

12. The no electric leak breaker for self-test of claim 11, wherein the control unit provides a critical voltage or a voltage higher than the critical voltage to the driving unit in a passive test operation.
